(19) United States
(12) Patent Application Publication
(10) Pub. No.: US 2012/0088048 A1
(43) Pub. Date: Apr. 12, 2012

(54) Process for producing fiber-reinforced composite materials

(75) Inventors: Dietrich Scherzer, Neustadt (DE); Philippe Desbois, Edingen-Neckarhausen (DE); Uwe Gleiter, Neustadt (DE); Martin Weber, Maikammer (DE); Michael Gall, Neustadt (DE)

(73) Assignee: BASF SE, Ludwigshafen (DE)

(21) Appl. No.: 13/267,628

(22) Filed: Oct. 6, 2011

Related U.S. Application Data
(63) Continuation-in-part of application No. 13/076,722, filed on Mar. 31, 2011.
(60) Provisional application No. 61/319,901, filed on Apr. 1, 2010.

(51) Int. Cl. B32B 5/02; B32B 1/00; C09D 177/02; C08G 69/26; C09D 177/06; B29C 70/30; C08G 69/14

(52) U.S. Cl. 428/36.1; 442/59; 264/258; 528/323; 528/335; 524/606

(57) ABSTRACT

The present invention relates to binders for the preforming process to which textile structures are subjected when structural materials are produced by the RIM or RTM method, where the binder composed of an amorphous polyimide is spray applied in a solvent onto the textile structure or onto the textile, and is used as binder for the preforming process. The present invention further relates to a process for producing moldings made of fiber-reinforced composite materials.

The present invention relates to binders for the preforming process to which textile structures are subjected when structural materials are produced by the RIM or RTM method, where the binder composed of an amorphous polyamide is spray applied in a solvent onto the textile structure or onto the textile, and is used as binder for the preforming process. The present invention further relates to a process for producing moldings made of fiber-reinforced composite materials.

A known process for producing fiber-reinforced sandwich components based on pourable polyamide uses what is known as the RTM (resin-transfer-molding) method. In this method, the core is arranged, with layers arranged thereon composed of dry fiber material, i.e. fiber material that has not been preimpregnated, in a mold that can be closed. The mold is composed of two heatable mold halves, the internal shape of which corresponds to the external shape of the finished component. Within the closed mold cavity, liquid resin is introduced into the dry fiber material. The resin is hardened via heating of the mold. Either superatmospheric pressure or vacuum can be used here for introducing the resin into the RTM mold. The respective pressure difference serves inter alia to avoid undesired air inclusions in the outer layer. Various disadvantages of prepreg technology are avoided by using dry scrims. EP-A-722 825 discloses the RTM method that uses superatmospheric pressure within the mold. Corresponding RTM methods proposing vacuum within the mold are known from EP-A-770 472, EP-A-786 330, and EP-A-1 281 505. WO-A-02/074469 discloses an RTM method in which resin is injected under superatmospheric pressure and the process is assisted by generating a vacuum within the gas-tight closed mold. However, these processes, too, have the attendant disadvantage of high purchase costs and high operating costs. One of the problems is that each type of component requires a specific, expensive heatable RTM mold.

In the literature, the expression “RIM method” is often used synonymously with “RTM method”. “RIM method” is also synonymous with “RTM method” for the purposes of the present invention.

However, the abovementioned processes are not entirely satisfactory. In particular, this approach encounters difficulties in producing fiber-reinforced composite materials with uniform quality. Specifically, it encounters difficulties in ensuring reproducibility of uniform mechanical properties.

It was therefore an object of the present invention to overcome the abovementioned disadvantages. Surprisingly, it has now been found that said object is achieved if a textile structure is first pretreated with a polymeric binder and is subjected to a molding step, and the resultant molded textile structure which comprises binder is brought into contact with a polymerizable composition, and the material is polymerized.

The invention firstly provides a process which uses polymerization of lactams in molds, with addition of textile structures, to produce fiber-composite moldings which are in essence sheet-like.

The present invention further provides a process for producing fiber-reinforced composite materials, using polyamides as binders.

The invention further provides a binder for the preforming process to which textile structures are subjected when structural materials are produced by the RIM or RTM method, where a binder composed of an amorphous polyamide is spray applied, in a solvent or in a solvent mixture onto the textile structure or onto the textile, and is used as binder for the preforming process.

The invention further provides a process for producing moldings made of fiber-reinforced composite materials, comprising:
A1) impregnation of a textile structure with at least one liquid binder composition in the form of a solution or dispersion of a polymeric binder in a solvent, and
A2) molding of the textile structure,

where the steps A1) and A2) can be carried out in any desired sequence, and where an impregnated, molded textile structure is obtained,
B) removal of the solvent from the impregnated, molded textile structure, to give a molded textile structure which comprises binder, and
C) impregnation, with a polymerizable composition, of a molded textile structure which comprises binder and which was obtained in step B), and polymerization of the polymerizable composition.

The present invention further provides composite material moldings which are obtainable by a process as defined above and hereinafter.

The invention further provides a shell for safety helmets as head-protection for persons, comprising or composed of said composite material molding.

For the purposes of the present invention, a “molding made of fiber-reinforced composite materials” denotes an article which comprises a fiber-reinforced composite material or consists of a fiber-reinforced composite material, and the shape of which is suitable for a desired use.

The process of the invention can improve the reproducibility of the technological properties of the material of the molding, via controlled introduction of textile structures that have been subjected to a preforming process. Among these properties are by way of example tensile strength, modulus of elasticity, impact resistance, and the like. For the purposes of the invention, textile structures are not only rovings, wovens, knits, and mats, but also nonwovens and felts; in advantageous embodiments of the invention these are therefore needlefelts, wovens, rovings, woven rovings, and mats, preferably made of glass fibers, carbon fibers, or synthetic fibers. The process involved therefore produces three-dimensional long-fiber-reinforced structural components based on pourable polyamides, on epoxy resins, or on polyurethane resins. The textile structure (fiber mat) used here can be subjected to a preforming process prior to processing.

For the preforming process, the textile can be sprayed with a solution of the amorphous polyamide (or of any other soluble thermoplastic), and the solvent can be evaporated. Ultramid® 1C in ethanolic solution has excellent compatibility with polyamide matrices and has particular suitability as sprayable coating composition and sprayable binder for fibers and textiles. The coating composition/binder exhibits very little or no inhibiting effect on pourable polyamides.

If the spray is applied to the textile after it has been subjected to a preforming process, it remains in the mold after evaporation of the solvent. However, the textiles thus treated can also be subjected to a forming process in a second step (preferably) via heating. The forming process can be carried out in the injection mold, or else in an upstream step.

By way of example, Kunststoffhandbuch “Duroplaste 10” [Plastics Handbook “Thermosets 10”], Hanserverlag 1988, on p. 825ff discloses processes for producing structural components.

Accordingly, a novel and improved process has been found for producing fiber-reinforced composite materials, and is characterized by
a) molding a textile structure and then spray-applying a binder, or saturating the textile structure with a binder, or
b) first spray-applying a binder to a textile structure, or saturating a textile structure with a binder, and then subjecting the material to forming and drying.

The textile that has been subjected to a preforming process can, after drying of the binder, either be left in the heated mold or introduced into the final polymerization mold, where, in the processes described, the caprolactam can be introduced together with the activators and catalysts; it saturates the textile structure and hardens.

The polymerization reaction can be carried out at mold temperatures of from 100 to 190° C., and the postpolymerization reaction can optionally be carried out at temperatures of from 80 to 150° C.

Sequence of Processing Steps:
1. cutting the textile(s) to shape
2. placing the textiles in the premold or RTM mold, and possibly carrying out a preforming process
3. introducing dissolved thermoplastic in the form of spray
4. evaporating solvent
5. closing the mold
6. preforming-process step
7. removing the textile component and transfer to RTM mold or further processing within the mold.

The preforming process described, using sprayable thermoplastics, is particularly simple and inexpensive, and is therefore suitable for long runs.

The process of the invention can be carried out as follows:

In one preferred embodiment, operations can follow what is known as the RTM (resin-transfer-molding) method or the RIM (reaction-injection-molding) method. In these methods, the core can be arranged, with layers arranged thereon made of dried textile structures comprising binder, in a mold that can be closed. The mold is generally composed of two heatable mold halves, the internal shape of which and the external shape of which corresponds to the finished components. Within the closed mold cavity, molten lactam, with the additives required for the polymerization reaction, can be introduced into the dry fiber material that has been subjected to a preforming process. The lactam can be hardened via heating of the mold. The resin here can be introduced at atmospheric pressure into the RTM mold or RIM mold, or preferably at a pressure of from 1.1 to 20 bar, preferably from 1.5 to 5 bar, particularly preferably from 1.0 to 3.0 bar, or at a pressure of from 0.001 to 0.9 bar, preferably from 0.1 to 0.8 bar, particularly preferably from 0.2 to 0.6 bar.

The polymeric binder used in the invention preferably comprises at least one thermoplastic polymer. In one specific embodiment, the polymeric binder consists of a thermoplastic polymer or of a mixture of thermoplastic polymers. It is preferable that the thermoplastic polymer has been selected from polyamides and blends of polyamides.

Examples of suitable materials are polyamides which derive from lactams having from 7 to 13 ring members, examples being polycaprolactam, polycaprylolactam, and polylaurolactam, and also polyamides which are obtained via reaction of dicarboxylic acids with diamines. Examples of dicarboxylic acids that can be used are alkanedicarboxylic acids having from 6 to 12, in particular from 6 to 10, carbon atoms, and aromatic dicarboxylic acids, in particular adipic acid, azelaic acid, sebacic acid, dodecanedioic acid, terephthalic acid, and/or isophthalic acid.

Particularly suitable diamines are alkanediamines having from 6 to 12 carbon atoms, and also aromatic diamines, such as m-xylylenediamine, di(4-aminophenyl)methane, di(4-aminocyclohexyl)methane, 2,2-di(4-aminophenyl)propane, 2,2-di(4-aminocyclohexyl)propane, and 1,5-diamino-2-methylpentane. Other suitable polyamides are those obtainable via copolymerization of two or more of the abovementioned monomers, and mixtures of a plurality of polyamides, where the mixing ratio is as desired. The nonexclusive list below comprises suitable polyamides and monomers of these (in parentheses).

PA 4 (pyrrolidone), PA 6 (ε-caprolactam), PA 7 (ethanolactam), PA 8 (capryloactam), PA 9 (9-aminopelargonic acid), PA 11 (11-aminoundecanoic acid), PA 12 (laurolactam), PA 46 (tetramethylenediamine, adipic acid), PA 66 (hexamethylenediamine, adipic acid), PA 69 (hexamethylenediamine, azelaic acid), PA 610 (hexamethylenediamine, sebacic acid), PA 612 (hexamethylenediamine, decanedicarboxylic acid), PA 613 (hexamethylenediamine, undecanedicarboxylic acid), PA 1212 (1,12-dodecanediamine, decanedicarboxylic acid), PA 1313 (1,13-diaminotridecane, undecanedicarboxylic acid), PA 6T (hexamethylenediamine, terephthalic acid), PA 9T (nonyldiamine, terephthalic acid), PA MXD6 (m-xylylene-diamine, adipic acid), PA 6I (hexamethylenediamine, isophthalic acid), PA 6-3-T (trimethylhexamethylenediamine, terephthalic acid), PA 6/6T (see PA 6 and PA 6T), PA 6/66 (see PA 6 and PA 66), PA 6/12 (see PA 6 and PA 12), PA 66/6/610 (see PA 66, PA 6 and PA 610), PA 6I/6T (see PA 6I and PA 6T), PA PACM 12 (diaminodicyclohexylmethane, laurolactam), PA 6I/6T/PACM (such as PA 6I/6T+diaminodicyclohexylmethane), PA 12/MACMI (laurolactam, dimethyldiaminodicyclohexylmethane, isophthalic acid), PA 12/MACMT (laurolactam, dimethyldiaminodicyclohexylmethane, terephthalic acid), PA PDA-T (phenylenediamine, terephthalic acid).

It is also possible to use mixtures of above polyamides.

Specifically, the thermoplastic polymer is selected from amorphous polyamides and blends of amorphous polyamides.

Suitable binders are specifically soluble polyamides, examples being amorphous polyamides, e.g. mixtures which do not readily crystallize and which are composed of nylon-6 and nylon-6,6, of polyamide derived from hexamethylenediamine and isophthalic acid (nylon-6,I), other suitable binders being other amorphous polyamides, or in general terms any of the soluble polyamides, but preferably amorphous mixtures made of aliphatic polyamides, and particularly preferably Ultramid® 1C from BASF SE, based on a mixture of nylon-6 and nylon-6,6.

The thermoplastic polymer is preferably one selected from nylon-6, nylon-6,6, nylon-6/6,6 and blends which comprise nylon-6, nylon-6,6 and/or nylon-6/6,6 as main constituent. The expression “main constituent” here means that a thermoplastic polymer composition is used which comprises at least 50%, based on the total weight, of nylon-6, nylon-6,6 and/or nylon-6/6,6.

A specifically suitable commercially available polymeric binder is Ultramid® 1C from BASF SE, which is a nylon-6/6,6/13,6.

Suitable solvents for the binder composition (specifically for the soluble polyamides) are water, alkanols, e.g. C₁-C₂₀ alkanols, e.g. methanol, ethanol, n-propanol, isopropanol, n-butanol, isobutanol, tert-butanol, n-pentanol, isopentanol, n-hexanol, isohexanol, n-heptanol, isoheptanol, n-octanol, isooctanol, and ketones, e.g. acetone, methyl ethyl ketone, and esters, e.g. ethyl acetate, and halogenated solvents, e.g. methylene chloride, chloroform, and carbon tetrachloride, or a mixture of these, preferably water, C₁-C₈ alkanols, e.g. methanol, ethanol, n-propanol, isopropanol, n-butanol, isobutanol, sec-butanol, tert-butanol, n-pentanol, isopentanol, n-hexanol, isohexanol, n-heptanol, isoheptanol, n-octanol, isooctanol, or a mixture of these, particularly preferably water, C₁-C₄ alkanols, e.g. methanol, ethanol, n-propanol, isopropanol, n-butanol, isobutanol, sec-butanol, tert-butanol, or a mixture of these.

The solvent used preferably comprises water or an aqueous alcoholic solvent. Water/ethanol mixtures and water/propanol mixtures are particularly preferred as solvent.

In one preferred embodiment, a solution of a polyamide or polyamide blend in a water/ethanol mixture or in a water/propanol mixture is used as liquid binder composition.

Suitable textile structures are wovens, nonwovens, and scrims based on carbon fibers, on glass fibers, on aramid fibers, on natural fibers, or a mixture of these, preferably glass fibers, carbon fibers, or aramid fibers, particularly preferably glass fibers and carbon fibers.

Once the textile structure has been subjected to (pre)forming and has been treated with a binder, it can then be impregnated with a polymerizable composition, and the polymerizable composition can then be subjected to a polymerization process.

The polymerizable composition is preferably one selected from polyamide resins, epoxy resins, and polyurethane resins.

It is preferable that the polymerizable composition comprises, as polymerizable constituents, a lactam or lactam resin.

Specifically suitable polymerizable compositions are obtainable as “pourable polyamides”.

Suitable thermosets are pourable polyamides, which here are the polymers derived from caprolactam and laurolactam, or a mixture of these.

ε-Caprolactam is preferably suitable as lactam.

A suitable method uses e-caprolactam as sole polymerizable constituent or uses a mixture which comprises ε-caprolactam and at least one component copolymerizable therewith.

Up to 20% by weight, i.e. from 0 to 20% by weight, preferably from 0 to 17% by weight, particularly preferably from 0 to 15% by weight, of the caprolactam can be used by comonomers from the group of the lactams having at least 4 carbon atoms. Particular preference is given to ω-laurolactam as comonomer.

One preferred embodiment can use a mixture of ε-caprolactam and ω-laurolactam. The mixing ratio is generally 1000:1, preferably 100:1, particularly preferably 10:1, in particular 2:1.

Other suitable starting materials for nylon-6 are activators which can be produced via reaction of isocyanates, such as HDI (hexamethylene diisocyanate) with lactams, such as ε-caprolactam, and other suitable starting materials are capped isocyanates, isophthaloylbiscaprolactam, terephthaloylbiscaprolactam, esters, e.g. dimethyl phthalate polyethylene glycol, polyols, or polydienes, in combination with acyl chlorides, carbonylbiscaprolactam, hexamethylene diisocyanate, or acyl lactamate, and preferred starting materials are isocyanates, hexamethylene diisocyanate, or acyl lactamate, particularly preferably hexamethylene diisocyanate, or acyl lactamate, and alkaline catalysts, e.g. magnesium halide lactamates, alkali metal caprolactamates, aluminum lactam or magnesium lactam, sodium caprolactamate, or magnesium bromide lactamate, preferably alkali metal caprolactamates, aluminum lactam or magnesium lactam, sodium caprolactamate, or magnesium bromide lactamate, particularly preferably sodium caprolactam or magnesium bromide lactamate.

Activators used can be any of the activators used for activated anionic polymerization reactions, examples therefore being N-acyllactams, e.g. N-acetylcaprolactam, substituted triazines, carbodimides, cyanamides, mono- and polyisocyanates, and the corresponding capped isocyanate compounds. The concentrations preferably used of the activators are from 0.1 to 1 mol %, based on the amount of lactam. By using the catalysts of the invention it is possible to polymerize lactams having at least 5 ring members, e.g. caprolactam, laurolactam, caprylolactam, or enantholactam, or the corresponding carbon-substituted lactams, or a mixture of the lactams mentioned.

The alkaline catalysts can be produced via reaction of the polyether with the corresponding alkali metal compound or the corresponding alkaline earth metal compound, e.g. with the alkylate, amide, hydride, or Grignard compounds, or else with the alkali metals or alkaline earth metals. The amounts generally used of the catalysts are from 0.1 to 40% by weight, preferably from 0.2 to 15% by weight, based on the lactam melt.

Catalysts with good suitability for the polymerization reaction are potassium lactamates or sodium lactamates. Sodium caprolactamate has particularly good suitability and can easily be produced from NaH and ε-caprolactam.

The mixing ratio of caprolactam, activator, and alkaline catalyst can be varied widely, but the molar ratio of caprolactam to activator to alkaline catalyst is generally from 1000:1:1 to 1000:200:50.

The fibers used can be from a natural or synthetic source. Fibers made of inorganic materials and fibers made of organic materials can be used to provide the textile structures. Fibers made of organic materials can comprise natural polymers, synthetic polymers, or a combination thereof, or can consist of natural polymers, or synthetic polymers, or of a combination thereof. Suitable fibers are inorganic materials, such as high-modulus carbon fibers, silicatic and nonsilicatic glasses of a very wide variety of types, carbon, boron, silicon carbide, metals, metal alloys, metal oxides, metal nitrides, metal carbides, and silicates, and also organic materials, e.g. natural and synthetic polymers, for example polyacrylonitriles, polyesters, ultrastretched polyolefin fibers, polyamides, polyimides, aramids, liquid-crystal polymers, polyphenylene sulfides, polyether ketones, polyether ether ketones, polyetherimides, cotton, cellulose, and other natural fibers, e.g. flax, sisal, kenaf, hemp, and abaca, but preferably high-melting-point materials, e.g. glass, carbon, aramids, liquid-crystal polymers, polyphenylene sulfides, polyether ketones, polyether ether ketones, and polyetherimides, and particularly preferably glass fibers, carbon fibers, aramid fibers, steel fibers, ceramic fibers, and/or other sufficiently heat-resistant polymeric fibers, or filaments.

Suitable reinforcing materials (specifically as textile structure) comprise rovings of the abovementioned fibers, preferably non-linear, and linear, particularly preferably sheet-like moldings, e.g. fibers, yarns, and textile structures, examples being wovens, knits, braids, and nonwovens.

The content of fibers in the finished composite material is generally from 20 to 85% by volume, preferably from 40 to 70% by volume, or in the case of profiles with purely monodirectional reinforcement from 30 to 90% by volume, preferably from 40 to 80% by volume.

The reinforcing material can have uniform distribution within the composite material of the invention, but its proportion present in certain portions of the composite material, e.g. in the peripheral regions, and/or in particular reinforcement zones, can also be greater than in other portions of the composite material.

The term composite material means materials made of two or more materials bonded together, examples being particulate composite materials (dispersion materials, fiber-composite materials, laminates, and interpenetration-composite materials, preferably fiber-composite materials and laminates, and particularly preferably fiber-composite materials.

The composite material parts produced in the invention are preferably suitable for use as shell for safety helmets as head-protection for persons. Among these are by way of example safety helmets for persons propelling a motor vehicle, motorcycle, pedal cycle, etc., safety helmets for sports activities, such as mountaineering, roller-skating, etc., safety helmets for children, safety helmets for preventing injury to disabled persons, and safety helmets for protection at work, e.g. in the construction industry, mining, etc.

The composite-material components produced in the invention are suitable specifically for use as shell for safety helmets which provide head-protection for persons driving a motor vehicle or motorcycle.

The present invention specifically provides a process for producing moldings made of fiber-reinforced composite materials, comprising:
A1) impregnation of a textile structure with at least one liquid binder composition in the form of a solution or dispersion of a polymeric binder in a solvent, and
A2) molding of the textile structure,

where the steps A1) and A2) can be carried out in any desired sequence, and where an impregnated, molded textile structure is obtained,
B) removal of the solvent from the impregnated, molded textile structure, to give a molded textile structure which comprises binder, and
C) impregnation, with a polymerizable composition, of the molded textile structure which comprises binder and which was obtained in step B), and polymerization of the polymerizable composition.

The invention further specifically provides composite material moldings obtainable by a process comprising the steps A1), A2), B), and C). The invention further specifically provides a shell for safety helmets as head-protection for persons, comprising or consisting of a composite material molding obtainable by a process comprising the steps A1), A2), B), and C).

For the impregnation process in the step A1), conventional methods known to the person skilled in the art can be used to bring the textile structure into contact with the at least one liquid binder composition. For the impregnation process in the step C), conventional processes known to the person skilled in the art can be used to bring the molded textile structure which comprises binder and which has been obtained in step B) into contact with the polymerizable composition. The impregnation process in steps A1) and C) can take place respectively mutually independently, e.g. via conventional application processes, such as spray application, spread application, pouring, dipping, print application, etc. The impregnation process can take place with the use of reduced pressure. A phase with increased pressure can optionally follow a phase with reduced pressure.

It is preferable to use spray application of the liquid binder composition to the textile structure in A1) for the impregnation process.

The textile structure used in step A1) or A2) serves as reinforcing material for producing the composite material moldings. Suitable textile structures are in principle fibers or fiber structures. The textile structure is preferably one selected from rovings, wovens (inclusive of microfiber wovens), knits, laid scrims, mats, nonwovens, felts, etc., and combinations thereof. Reference is made here to the above descriptions of suitable and preferred textile structures. The textile structure used in step A1) or A2) comprises, or preferably consists of, glass fibers, carbon fibers, and/or fibers of heat-resistant plastics. Particular preference is given to textile structures based on glass fibers, on carbon fibers, or on aramid fibers, specifically on glass fibers or on carbon fibers.

The liquid binder composition used in step A1) preferably comprises from 1 to 30% by weight, particularly from 2 to 20% by weight, based on its total weight, of the polymeric binder.

The polymeric binder comprised in the binder composition preferably comprises at least one thermoplastic polymer.

In one specific embodiment, the polymeric binder comprised in the binder composition consists of a thermoplastic polymer or of a mixture of thermoplastic polymers.

The thermoplastic polymer is preferably one selected from polyamides and blends of polyamides.

It is also possible to use a mixture of the abovementioned polyamides.

The thermoplastic polymer is especially selected from among amorphous polyamides and blends of amorphous polyamides.

It is preferable that the thermoplastic polymer is one selected from nylon-6, nylon-6,6, nylon-6/6,6, and blends which comprise nylon-6, nylon-6,6, and/or nylon-6/6,6, as main constituent. The expression “main constituent” here means that a thermoplastic polymer composition is used which comprises at least 50%, based on the total weight, of nylon-6, nylon-6,6 and/or nylon-6/6,6.

A specifically suitable commercially available polymeric binder is Ultramid® 1C from BASF SE, which is a nylon-6/6,6/13,6.

With respect to the solvent used in step A1), reference is made to the abovementioned information relating to suitable and preferred solvents.

Solvent used is preferably water or an aqueous alcoholic solvent. Water/ethanol mixtures and water/propanol mixtures are particularly preferred as solvent.

In one preferred embodiment, a solution of a polyamide or polyamide blend in a water/ethanol mixture or in a water/propanol mixture is used as liquid binder composition.

In step B) of the process of the invention, the solvent is removed at least to some extent. This gives a molded textile structure which comprises binder and which is then, in step C), impregnated with a polymerizable composition, and subjected to a polymerization process.

Conventional processes known to the person skilled in the art can be used to remove the solvent at least to some extent in step B). Among these is preferably evaporation at reduced pressure and/or elevated temperature.

The proportion of the solvent removed in step B) is preferably at least 30% by weight, preferably at least 50% by weight, in particular at least 70% by weight, based on the original amount of solvent. Specifically, at least 80% by weight of the solvent is removed, more specifically at least 90% by weight, based on the amount originally used.

Steps A1), A2), and B) are preferably carried out in such a way that the resultant molded textile structure which comprises binder comprises from 5 to 200 g/kg of polymeric binder.

In step C) of the process of the invention, the molded textile structure which comprises binder and which was obtained in step B) is impregnated with a polymerizable composition, and is then subjected to a polymerization process.

Step C) preferably uses an RIM process or RTM process.

The polymerizable composition used in step C) is preferably one selected from polyamide resins, epoxy resins, and polyurethane resins.

It is preferable that the polymerizable composition comprises, as polymerizable constituents, a lactam or lactam resin. Specifically suitable polymerizable compositions are known and obtainable as “pourable polyamides”.

The polymerizable composition used in step C) preferably comprises ε-caprolactam as polymerizable constituent. A suitable method uses ε-caprolactam as sole polymerizable constituent or uses a mixture which comprises ε-caprolactam and at least one component copolymerizable therewith. Up to 20% by weight, i.e. from 0 to 20% by weight, preferably from 0 to 17% by weight, particularly preferably from 0 to 15% by weight, of the caprolactam can be used by comonomers from the group of the lactams having at least 4 carbon atoms. Particular preference is given to ω-laurolactam as comonomer.

In one preferred embodiment, a mixture of ε-caprolactam and ω-laurolactam is used as polymerizable composition. The mixing ratio of ε-caprolactam and ω-laurolactam is generally from 1000:1 to 1:1000, preferably from 100:1 to 1:100, particularly preferably from 10:1 to 1:10, in particular from 2:1 to 1:2.

With regard to further components of the polymerizable composition used in step C), specifically activators and catalysts, reference is made to the above information relating to said components.

The polymerization process in step C) can take place in the presence of at least one alkaline catalyst. Suitable alkaline catalysts can be produced via reaction of a polyether with the corresponding alkali metal compound or alkaline earth metal compound, e.g. the alcoholate, amide, hydride, Grignard compounds or else with the alkali metals or alkaline earth metals. The amounts generally added to the catalysts are from 0.1 to 40% by weight, preferably from 0.2 to 15% by weight, based on the polymerizable components.

Catalysts with good suitability for the polymerization process are potassium lactamates or sodium lactamates. Sodium caprolactamate has particularly good suitability. This can be produced easily, e.g. from NaH and ε-caprolactam.

The mixing ratio of caprolactam, activator, and alkaline catalyst can be varied widely, but the molar ratio of caprolactam to activator to alkaline catalyst is generally from 1000:1:1 to 1000:200:50.

The polymerization process in step C) preferably takes place at a temperature in the range from 50 to 250° C., particularly preferably from 70 to 200° C., specifically from 100 to 190° C.

In one particularly preferred embodiment, a thermoplastic polymer is used in the binder composition and has been selected from polyamides and blends of polyamides, and a polymerizable composition is used which comprises, as polymerizable constituents, a lactam or lactam resin. This type of system features excellent compatibility of the components used. In particular, the binder composition exhibits no, or only slight, inhibiting effect on the polymerizable composition.

The fiber content of the composite material moldings obtainable by the process comprising the steps A1), A2), B), and C) is preferably from 20 to 85% by volume, particularly preferably from 40 to 70% by volume, based on the total volume of the composite material molding. One specific embodiment is provided by composite material moldings with purely unidirectional reinforcement.

The fiber content of composite material moldings with purely unidirectional reinforcement is preferably from 30 to 90% by volume, particularly preferably from 40 to 80% by volume, based on the total volume of the composite material molding.

The composite material parts produced by the process comprising the steps A1), A2), B), and C) are preferably suitable for use as shell for safety helmets as head-protection for persons. Among these are by way of example safety helmets for persons propelling or driving a motor vehicle, motorcycle, pedal cycle, etc., safety helmets for sports activities, such as mountaineering, roller-skating, etc., safety helmets for children, safety helmets for preventing injury to disabled persons, and safety helmets for protection at work, e.g. in the construction industry, mining, etc.

### EXAMPLES

The textiles or textile structures used to reinforce the components are either preinserted into the mold, saturated with the binder, and subjected to a preforming process via closure of the mold and evaporation of the solvent, where the activated and catalyzed lactam is injected, or are subjected to a preforming process in a second heated mold, and then introduced into the polymerization mold.

Starting Materials:
Polyamide: Ultramid® 1C (BASF SE)
Catalyst: sodium caprolactamate at from 17 to 19% by weight in caprolactam: Brüggolene® C10 (Brüggemann, Heilbronn)
Activator: 17% by weight capped diisocyanate in caprolactam: Brüggolene® C20 (Brüggemann, Heilbronn)
Pourable Polyamide: caprolactam: AP-Nylon® caprolactam (Brüggemann, Heilbronn)

### Inventive Example 1

5 layers of a 5×90/10 glass fiber mat (producer: Saertex) (weight per unit area 424 g/m²) were inserted into the mold (hat mold), and molded manually to the shape, and 50 ml of a solution made of 10% by weight of Ultramid@ 1C (BASF SE) in ethanol/water, ratio 9:1 by volume was sprayed onto the material. After drying to remove the solvent at from 30 to 150° C., the mold was closed and, at a mold temperature of 150° C., filled with a pourable polyamide based on caprolactam. The catalyst used comprised Brüggolene C10, and the activator used comprised Brüggolene C20. The low-water-content caprolactam used was likewise from Brüggemann (AP-Nylon® Caprolactam). The activator and catalyst were used in accordance with the data sheet. The pourable polyamide was introduced in two streams, which were mixed immediately prior to their use. The first stream comprised about 1 to 3% by weight of activator, and the second stream comprised about 1.5 to 3% by weight of catalyst. The molding was removed after 4 minutes.

The resultant molding was perfect, with no surface defects.

### Comparative Example A

The 5×90/10 glass fiber mats (produced by Saertex) (weight per unit area 424 g/m²) used for reinforcement were inserted into the mold (hat mold), and molded by hand to the shape. At a mold temperature of 150° C., the mold was filled, as described above, with a pourable polyamide system from Brüggemann (Heilbronn).

The inserted textiles had slipped out of place, and surface defects made the quality of the resultant molding unsatisfactory.

1. A process for producing fiber-reinforced composite materials, by
a) molding a textile structure and then spray-applying a binder, or saturating the textile structure with a binder, or
b) first spray-applying a binder to a textile structure, or saturating a textile structure with a binder, and then subjecting the material to forming and drying.

2. A binder for the preforming process used on textile structures when producing structural materials by the RIM or RTM method, wherein the binder composed of an amorphous polyamide is spray-applied in a solvent or in a solvent mixture onto the textile structure or onto the textile, and is used as binder for the preforming process.

3. A binder for the preforming process used on textile structures when producing structural materials by the RIM or RTM method according to claim 2, wherein the binder composed of an amorphous polyamide is spray-applied in an aqueous alcoholic solution onto the textile structure of the textile, and is used as binder for the preforming process, where this can take place in one or two stages.

4. The binder according to claim 2 or 3, based on polyamide blends comprising nylon-6 or nylon-6,6.

5. The binder according to claim 2 or 4, based on Ultramid® C.

6. The binder according to claim 2 or 5, based on a solution of the polyamide or polyamides in a water/ethanol or water/propanol solution.

7. A process for producing composite materials by the RTM or RIM method, utilizing the binders according to any of claims 2 to 5.

8. A composite-material component produced by a process according to claim 1 or 7.

9. The use of the composite-material components according to claim 8 as shell for safety helmets which provide head-protection for persons driving a motor vehicle or motorcycle.

10. The use of the composite-material components according to claim 1 or 7 as shell for safety helmets which provide head-protection for persons driving a motor vehicle or motorcycle.

11. A process for producing moldings made of fiber-reinforced composite materials, comprising:
A1) impregnation of a textile structure with at least one liquid binder composition in the form of a solution or dispersion of a polymeric binder in a solvent, and
A2) molding of the textile structure,
where the steps A1) and A2) can be carried out in any desired sequence, and where an impregnated, molded textile structure is obtained,
B) removal of the solvent from the impregnated, molded textile structure, to give a molded textile structure which comprises binder, and
C) impregnation, with a polymerizable composition, of a molded textile structure which comprises binder and which was obtained in step B), and polymerization of the polymerizable composition.

12. The process according to claim 11, where the binder comprised in the binder composition is a thermoplastic polymer or a mixture of thermoplastic polymers.

13. The process according to claim 12, where the thermoplastic polymer has been selected from polyamides and blends of polyamides.

14. The process according to claim 12, where the thermoplastic polymer has been selected from amorphous polyamides and blends of amorphous polyamides.

15. The process according to claim 14, where the thermoplastic polymer has been selected from nylon-6, nylon-6,6, nylon-6/6,6, and blends which comprise nylon-6, nylon-6,6, and/or nylon-6/6,6 as main constituent.

16. The process according to claim 11, where the solvent is water or an aqueous-alcoholic solvent.

17. The process according to claim 11, where liquid binder composition used comprises a solution of a polyamide or of a polyamide blend in a water/ethanol mixture or in a water/propanol mixture.

18. The process according to claim 11, where the liquid binder composition comprises, based on its total weight, from 2 to 20% by weight of the polymeric binder.

19. The process according to claim 11, where, for the impregnation process, the textile structure is sprayed in step A1) with the liquid binder composition.

20. The process according to claim 11, where the steps A1), A2), and B) are carried out in such a way that the molded textile structure which comprises binder comprises from 5 to 200 g/kg of polymeric binder.

21. The process according to claim 11, where the polymerizable composition comprises, as polymerizable constituents, a lactam or lactam resin.

22. The process according to claim 11, where step C) is a RIM process or RTM process.

23. A composite material molding obtainable by a process according to any of claims 11 to 22.

24. A shell for safety helmets as head-protection for persons, comprising or consisting of a composite material molding according to claim 23.

25. A shell for safety helmets as head-protection for persons, comprising or consisting of a composite material molding, produced by a process as defined in any of claims 11 to 22.
